(19) United States
(12) Patent Application Publication
(10) Pub. No.: US 2013/0204732 A1
(43) Pub. Date: Aug. 8, 2013

(54) Methods and Systems for Conducting an Electronic Auction

(71) Applicant: Northcore Technologies Inc., Toronto (CA)

(72) Inventors: James Moskos, Mississauga (CA); Amit Singh Monga, Toronto (CA)

(73) Assignee: Northcore Technologies Inc., Toronto (CA)

(21) Appl. No.: 13/757,017

(22) Filed: Feb. 1, 2013

Related U.S. Application Data
(60) Provisional application No. 61/594,674, filed on Feb. 3, 2012.

(51) Int. Cl. G06Q 30/08

(52) U.S. Cl. CPC G06Q 30/08
USPC 705/26.3

(57) ABSTRACT

The embodiments described herein provide in one aspect, a method of conducting an electronic auction for a product at a server, wherein a finite number of the product is available at a current price and the current price decreases as an auction time period for completing the electronic auction decreases, the method comprising the server: setting the auction time period for completing the electronic auction; providing a user interface for receiving an input for purchasing one or more of the finite number of the product at the current price; monitoring interest in the electronic auction using an interest indicator associated with the electronic auction; decreasing the current price by a variable price decrement as the auction time period decreases, wherein the variable price decrement corresponds inversely with the interest in the electronic auction; and displaying the current price on the user interface as the current price decreases.

### CROSS-REFERENCE TO RELATED APPLICATION

This application claims benefit of U.S. Provisional Patent Application No. 61/594,674, entitled “Methods and Systems for Conducting an Electronic Auction”, filed Feb. 3, 2012. The entire contents of U.S. Provisional Patent Application No. 61/594,674 are hereby incorporated by reference.

### FIELD

The described embodiments relate to methods and systems for conducting an electronic auction.

### BACKGROUND

Electronic auctions, or online auctions, can take various forms.

One form of electronic auction begins with a low start price which is increased with each successive bid from one or more bidders. In such auctions, there is typically only one winning bid, that is, the bid that increases the price to a point that no other bidder displaces.

Another form of auction (sometimes known as a “Dutch Auction” or a reverse auction) begins with a high start price which decreases in a set manner during an auction time period and each participant is provided with the current price, the quantity on hand and the time remaining in the auction. A participant may purchase the product at any time they are comfortable with the price. The auction terminates when there is no more product to be sold or the auction time period expires.

### SUMMARY

In a first aspect, some embodiments of the invention provide a method of conducting an electronic auction for a product at a server, wherein a finite number of the product is available at a current price and the current price decreases as a auction time period for completing the electronic auction decreases, the method comprising the server:
setting the auction time period for completing the electronic auction;
providing a user interface for receiving an input for purchasing one or more of the finite number of the product at the current price;
monitoring interest in the electronic auction using an interest indicator associated with the electronic auction;
decreasing the current price by a variable price decrement as the auction time period decreases, wherein the variable price decrement corresponds inversely with the interest in the electronic auction; and
displaying the current price on the user interface as the current price decreases.

In a second aspect, some embodiments of the invention provide a method of conducting an electronic auction for a product at a server, wherein a finite number of the product is available at a current price and the current price decreases as an auction time period for completing the electronic auction decreases, the method comprising the server:
providing a user interface to indicate availability of the electronic auction prior to beginning the electronic auction;
monitoring, via the user interface, interest in the electronic auction using an interest indicator, wherein the monitoring comprises determining an initial interest level in the electronic auction;
selecting a threshold interest level for triggering a beginning of the electronic auction; and
beginning the electronic auction if the initial interest level exceeds the threshold interest level.

### BRIEF DESCRIPTION OF THE DRAWINGS

An embodiment of the present invention will now be described in detail with reference to the drawings, in which:

FIG. 1 is a block diagram of a system for conducting an electronic auction, in accordance with an embodiment of the present disclosure;

FIG. 2 is a flowchart diagram illustrating the steps of conducting an electronic auction for a product, in accordance with an embodiment of the present disclosure;

FIG. 3 is a line graph illustrating an example decrease in price by a variable price decrement over an auction time period in an electronic auction, in accordance with an embodiment of the present disclosure;

FIGS. 4A, 4B and 4C are example user interface screenshots for an electronic auction after one or more price update time intervals elapsed, in accordance with an embodiment of the present disclosure;

FIG. 5 is a flowchart diagram illustrating the steps of conducting an electronic auction for a product, in accordance with another embodiment of the present disclosure; and

FIGS. 6A and 6B are example screenshots of an example user interface for an electronic auction at different points in time during an auction time period, in accordance with another embodiment of the present disclosure.

### DESCRIPTION OF EXEMPLARY EMBODIMENTS

Electronic Dutch Auctions typically operate by decreasing the current price by a static decrement amount over an auction time period. The auction ends when there is no more product to sell, or the auction time period expires. As the auction progresses, participants typically try to outwait each other so that the price can decrease as much as possible. Once a buyer decides to buy and a “market price” is set, there is typically a flurry of activity as many other buyers also decide to buy before all of the product is sold.

Such auctions may result in the seller losing margin on various transactions. For example, the current price for the product may continue to be decremented even while buyers are willing to pay the current price.

Also, the current price may decrease by a larger amount than is necessary. For example, an auction may be set to start selling items at $10.00 each, and the price may be set to decline by $0.50 every 10 minutes. If a first buyer decides to start purchasing at the $7.50 price point (such that other potential buyers start to see the quantities decline), other buyers may be willing to start buying even if the auction has not reached the price they desired. Lowering the current price point to the next price point ($7.00) at this stage may result in the auction losing out on the buyers who were willing to buy at the intermediate price points between $7.50 and $7.00.

Unlike in live auctions, providers of electronic auctions typically do not have any direct interaction with participants of electronic auctions. In a live Dutch Auction, auctioneers may be able to vary aspects of the auction based on the direct interaction they have with participants. For example, an auctioneer may be able to slow the decrease in the current auction price before lowering the price again if there are a large number of bidders to entice additional buyers to purchase.

There is, thus, a need for improved methods and systems for conducting an electronic auction.

From a high-level perspective, the subject embodiments are generally directed at systems and methods of linking indicators of interest in an electronic auction with various aspects of the electronic auction to increase seller returns in the electronic auction.

In one embodiment, as the auction proceeds, the system described herein may be configured to decrease the current price by a variable price decrement—e.g., the price decrement amount may be changed such that it corresponds inversely with the interest in the electronic auction.

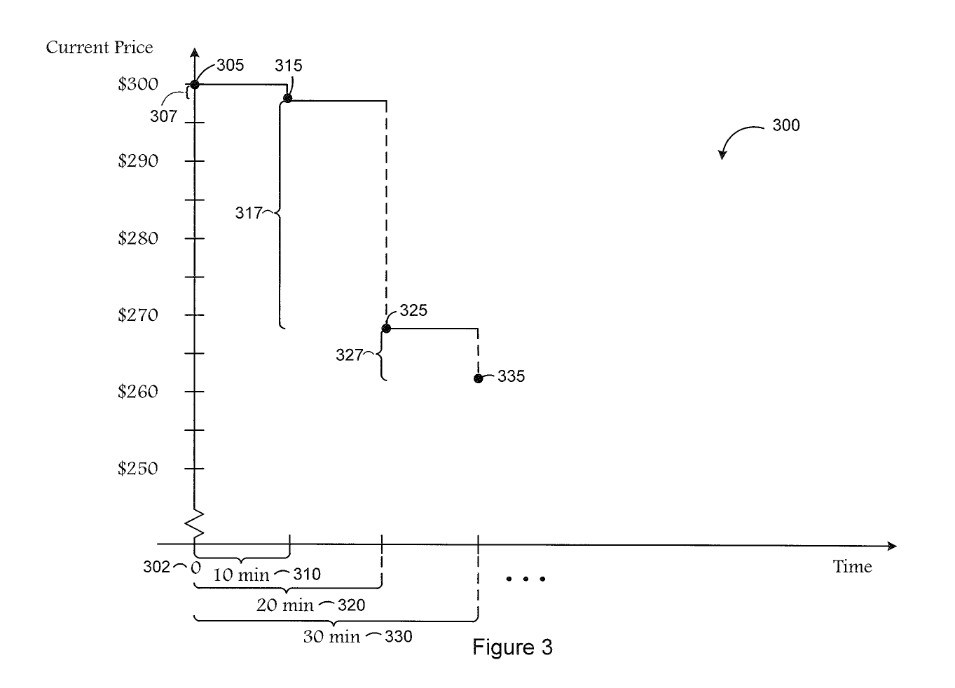

To illustrate this from a high-level, reference is made briefly to FIG. 3, where a line graph is shown plotting a current price on the y-axis against elapsed time on the x-axis. On this line graph, for every time interval of ‘10 min’ on the x-axis, the current price in the auction is decremented. In this example, an auction may start with a current price of $300 that is initially set to decrement by a $2.00 every time interval of ‘10 min’. This is illustrated in the line graph as the price decreasing by a small amount 307 after the first time interval 310. Since the price is still relatively high, the interest level in the auction after the first time interval may be low as buyers await the price to decrease. As such, the auction system of the present disclosure may increase the price decrement at the next time interval. This is illustrated in the line graph as a large price drop 317 (from $298 to $270) at the second time interval 320. As a result of the large price decrease, the interest level in the auction may have heightened. As a result, it may not be desirable to repeat the large price decrement (e.g., $18—the decrease from $298 to $270) again at the third time interval 330. The system may thus decrease the price decrement amount so as to capture additional buyers who would be willing to purchase without the large price drop. As a result, at the third time interval 330, the price decrement amount 327 is lowered to approximately $8 (the difference between $270 and $262).

Interest in an electronic auction may be indicated by various metrics, such as, for example, the number of current visitors to a website displaying the electronic auction. Such metrics will be discussed in greater detail below, and will be referred to as “interest indicators”.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor (e.g., a microprocessor), a data storage system (including volatile and non-volatile memory and/or storage elements), at least one input device, and at least one output device. For example and without limitation, the programmable computers (referred to below as computing devices) may be a personal computer, laptop, personal data assistant, cellular telephone, smart-phone device, tablet computer, and/or wireless device. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Moreover, the subject system may be implemented as one or more software components stored on a computer server that is accessible via a client machine in a client-server architecture. In such case, the system can be considered to be a hosted software offering or a software service employed in a software-as-a-service deployment.

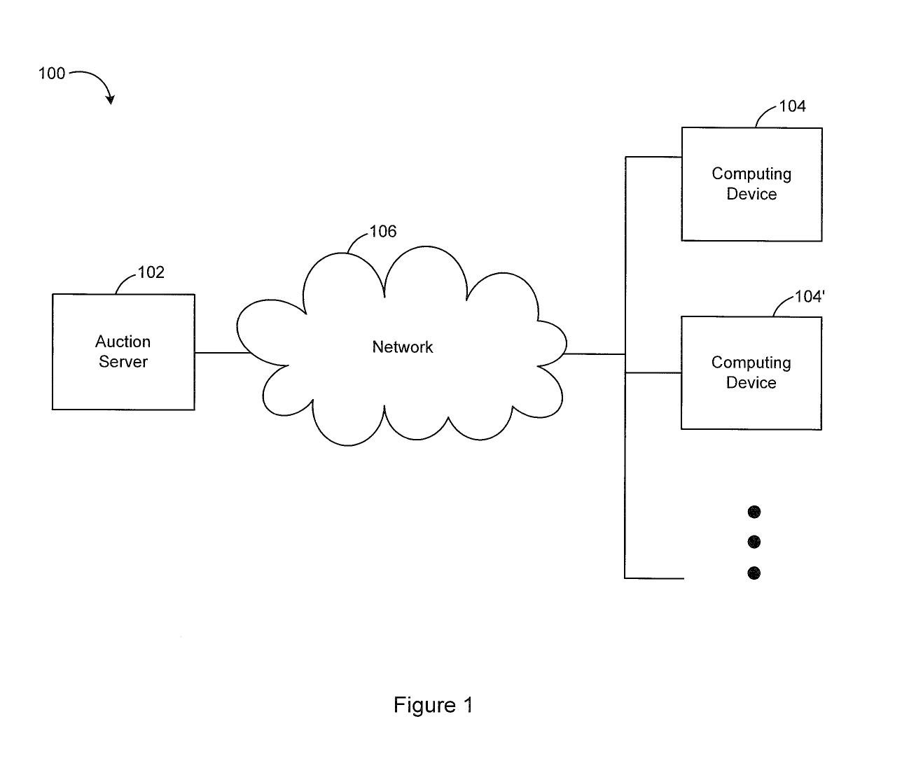

Reference is first made to FIG. 1, a block diagram of a system 100 for conducting an electronic auction in accordance with an embodiment of the present disclosure. The system 100 includes an auction server 102 and one or more computing devices 104, 104′, each connected to a network 106. It will be understood that the system 100 may be operable to communicate with one or more computing devices 104, 104′, and that the illustrated embodiment is merely an example and other configurations may be used.

Auction server 102 may include a network interface for connecting to the network 106, for example, to communicate with the computing devices 104, 104′. Similarly, the system 100 and the computing devices 104, 104′ may each have a network interface for connecting to the network 106 to communicate with each other and/or the auction server 102.

The auction server 102 may include one or more processors with computing processing abilities and memory such as a database or file system. In some embodiments, the auction server 102 may include more than one database and/or file system. Although only one auction server 102 is shown for ease of exposition, there may be multiple auction servers 102 distributed over a wide geographic area and connected via network 106.

Information related to the electronic auction that may be stored in a database on the auction server 102 may, for example, include information about the product, auction parameters (e.g., an auction time period indicating the duration of the auction, an auction start time, an auction end time, a start price, a current price, a price update time interval indicating the amount of time to elapse before decrementing the current price, etc.), an auction status information (e.g., whether the auction has begun), purchasing statistics (e.g., a quantity of product purchased over a portion of the auction time period), and web analytics information (e.g. access to the user interface (UI), a number of unique accessors to the UI, etc.).

The database on the auction server 102 may also store information related to interest indicators. As discussed above, interest indicators may be metrics stored by auction server 102 that indicate an interest in the electronic auction. For example, interest indicators may include: a rate at which the product is purchased over a portion of the auction time period, a frequency at which the UI is accessed over a portion of the auction time period, a number of unique accessors of the UI over a portion of the auction time period and/or whether one or more user interface control on the UI has been manipulated.

The network 106 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

In some embodiments, the network 106 may be any network which allows access to the auction server 102 from remote locations outside of a Local Area Network (LAN) within which the auction server 102 operates.

Each of the computing devices 104, 104′ may be any networked device operable to connect to the network 106. A networked device is a device capable of communicating with other devices through a network such as the network 106. A network device may couple to the network 106 through a wired or wireless connection.

As noted, these computing devices may include at least a processor and memory for storing instructions executable by the processor, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

In some embodiments, these computing devices 104, 104′ may be a laptop, or a smartphone device equipped with a network adapter for connecting to the Internet. In some embodiments, the connection request initiated from the computing devices 104, 104′ may be initiated from a web browser and directed at the browser-based communications application (e.g., a web server such as Apache™) on the auction server 102.

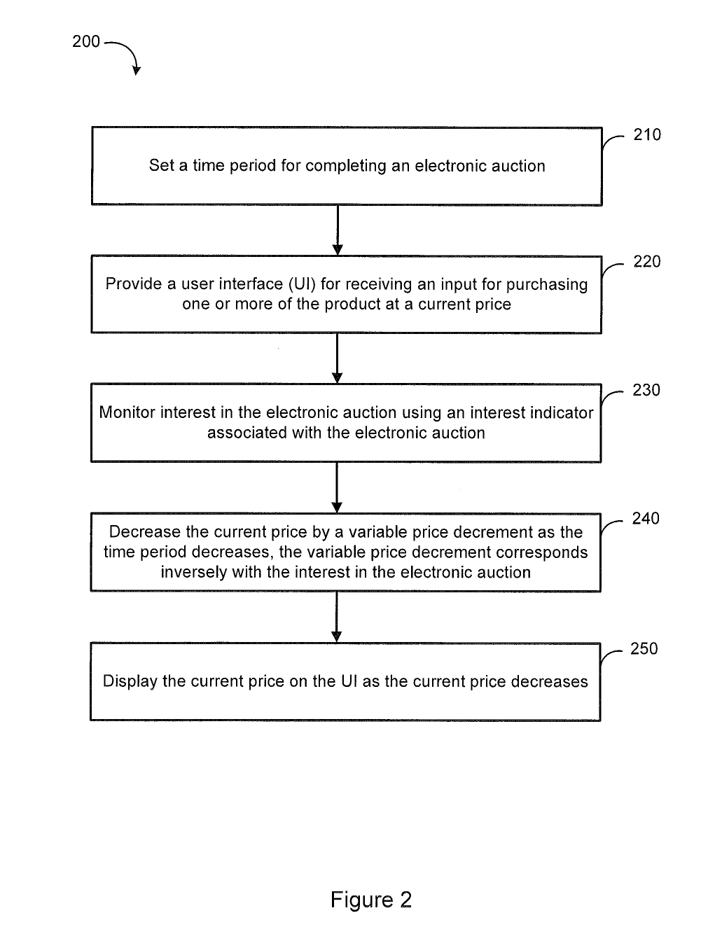

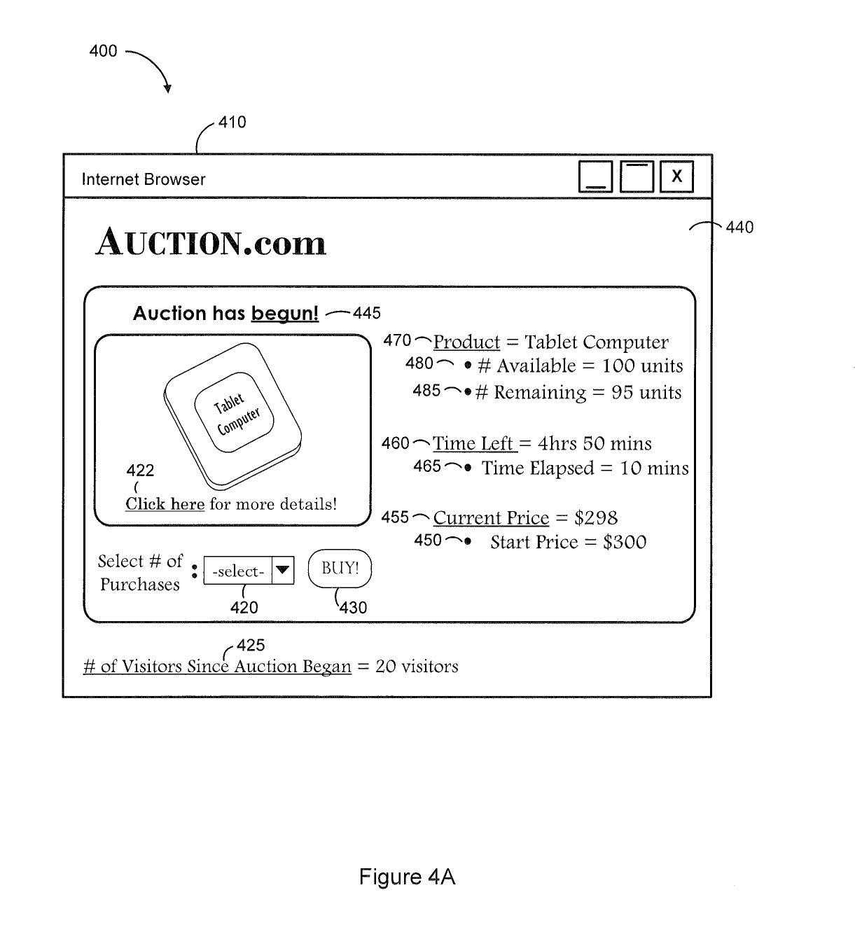

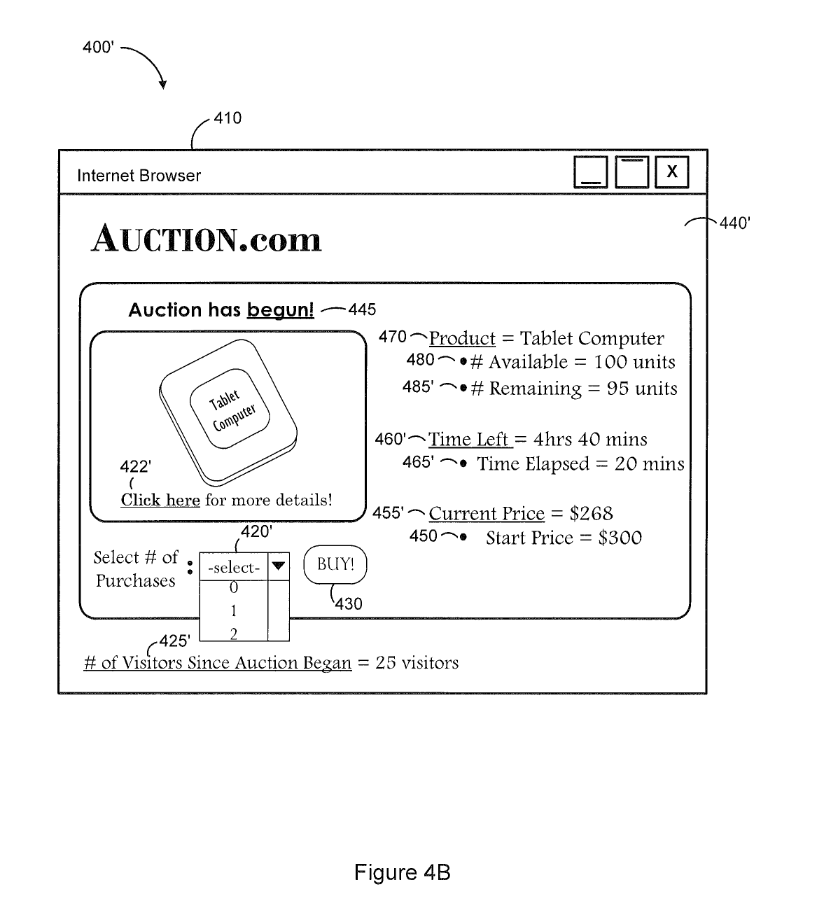

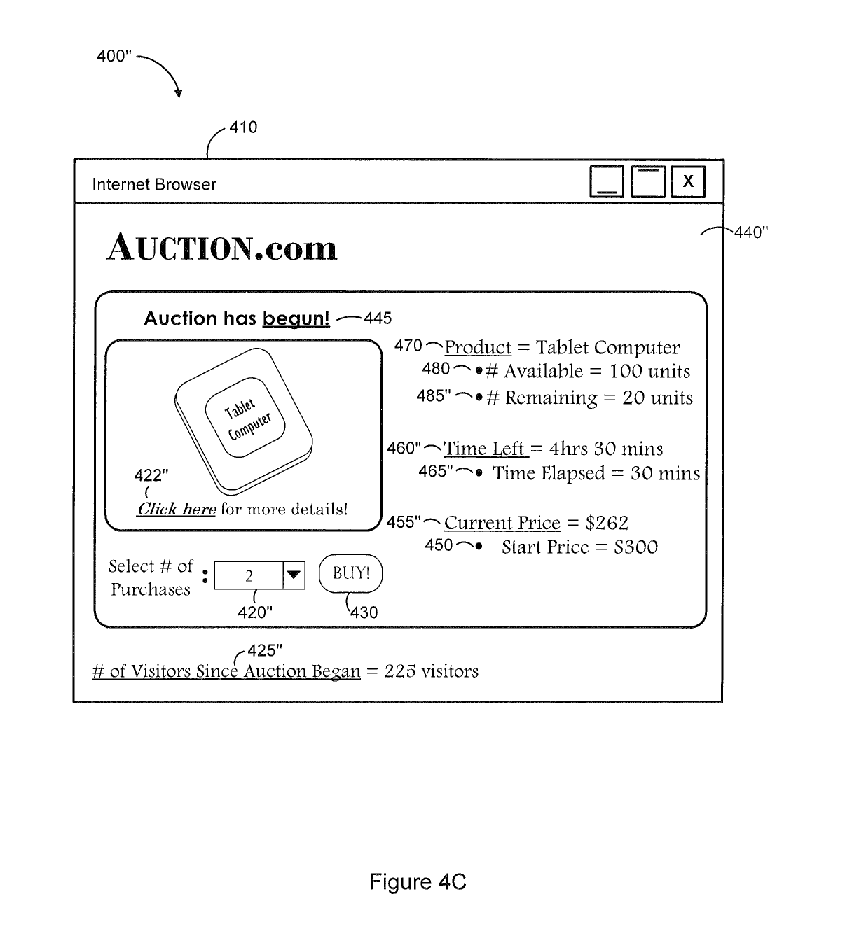

Referring to FIG. 2, illustrated therein generally as 200, is a flowchart diagram illustrating the steps of conducting an electronic auction, in accordance with an embodiment of the present disclosure. To illustrate the steps of the method, reference will be made simultaneously to FIG. 3, and FIG. 4A-4C, which illustrates a screenshots 400 of an example user interface for the electronic auction at three different time periods over the course of an electronic auction of the subject embodiments.

At step 210, the auction server 102 may set an auction time period for completing the electronic auction. The electronic auction is for selling a finite number of the product available at a current price that decreases as an auction time period for completing the electronic auction decreases.

As discussed above, the auction server 102 may include a database for storing information related to the auction. The auction server 102 may set the auction time period for completing the electronic auction by, for example, receiving input from an auction administrator who may set different auction time periods for different types of items being auctioned.

At step 220, the auction server 102 may provide a user interface (UI) for receiving an input for purchasing one or more of the finite number of the product at the current price.

Referring simultaneously to FIG. 4A, illustrated therein generally as 400, is a screenshot of an example user interface for an electronic auction, in accordance with an embodiment of the present disclosure. In the illustrated example screenshot 400, the UI 440 for the electronic auction is presented on an electronic webpage and accessed from an internet browser 410 of a computing device 104.

It will be understood that providing the UI 440 of the electronic auction on the electronic webpage and the illustrated display configuration UI elements in the example screenshot 400 are merely examples, and that other methods for providing and presenting the UI 440 may be possible. For example, in another embodiment, the UI 440 for the electronic auction may be published through one or more smartphone applications and accessed from one or more smartphone devices.

As illustrated in FIG. 4A, details about the auction may be provided in various data fields on the UI 440. The data fields may include one or more static fields for displaying information that do not change throughout a course of the auction and one or more dynamic fields for displaying information that are updated during the auction. The one or more static fields may include a product identification field 470 that identifies a product for auction, a start price field 450 that displays a start price of the product, and an available number field 480 that displays an available number of the product.

The dynamic field(s) may include an auction status field 445 that identifies a status of the auction (e.g., whether the auction has not begun, begun or ended), a current price field 455 that displays a current price of the product, a remaining time field 460 that displays a remaining auction time period for which the auction is available, remaining quantity field 485 that displays a remaining quantity of the product, a number of visitors field 425 that identifies a number of visitors to the auction webpage since the auction began, and a time elapsed field 465 that displays an auction time period that has elapsed since the auction begun. In some embodiments, the number of visitors field 425 may display a count of each and every access of the UI 440. In some other embodiments, the number of visitors field 425 may display a count of only the unique accessors of the UI 440.

It will be understood that the described fields are provided for illustrative purposes only, and that additional, fewer or alternative fields may be used in various embodiments.

As described above, data information corresponding to both the static and dynamic data fields may be stored in the database for storing information related to the auction on the auction server 102.

Furthermore, one or more controls may be included in the UI 440 of an electronic auction for receiving input from the user. For example, a purchasing control 430 may be included in the UI 440 for receiving input from the user for purchasing the product at the current price. The purchasing control 430 may be a button, such as a ‘Buy’ button 430 illustrated in FIG. 4A.

Another example control may be a quantity selecting control 420 for receiving input from a user for selecting the quantity of the product to be purchased. The quantity selecting control 420 may be a drop-down list, such as the numerical drop-down list in FIG. 4A. Other controls, such as a text field or a combo box may also be used in various embodiments.

A further example control may be a product information control 422 for receiving input from a user for requesting additional information regarding the product on auction. The product information control 422 may be a Uniform Resource Locator (URL) link, such as the “Click here” link 422 in FIG. 4A. In this example, when the auction server 102 receives the input from the product information control 422, the auction server 102 responds by providing additional information about the product on auction. In some embodiments, the auction server 102 may provide the additional information by providing a new display window in the browser 410. In some other embodiments, the auction server 102 may redirect the user to another webpage describing the product. It will be understood that the described methods for providing the additional information are merely examples, and that other methods may be used.

At step 230, the auction server 102 may monitor interest in the electronic auction using an interest indicator associated with the electronic auction. Generally, the interest indicator associated with the electronic auction indicates a level of interest from actual or potential auction participants associated with the electronic auction. The auction server 102 may store and provide access to information relating to interest indicators in the database of the auction server 102.

As indicated above, the present disclosure describes several example interest indicators: a rate at which the product is purchased through the UI 440, a frequency at which the UI 440 is accessed, a number of unique accessors of the UI 440, and detected manipulation of a user interface control on the UI 440.

The rate at which the product is purchased may be determined by assessing a quantity of the product purchased over a portion of the auction time period. The auction server 102 may determine such rate by, for example, tracking a time stamp associated with each purchase, and subsequently calculating the total quantity of the product purchased in the specified portion of the auction time period.

The frequency at which the UI 440 is accessed may also be determined with respect to a portion of the auction time period. Such frequency may be determined using web analytics information. The web analytics information may include information associated with traffic on a webpage or a web site, including a number of page views, or a number of visitors to the web site or the webpage, etc. The auction server 102 may track such web analytics information in the form of one or more log files. It will be understood that the described methods for determining the frequency at which the UI 440 is accessed over a specified portion of the auction time period are merely examples, and that other methods may be used.

The number of unique accessors is similar to the frequency at which the UI 440 is accessed but the number of unique accessors does not include any access to the UI 440 by the same computing device 104 and/or user. In some embodiments, the auction server 102 may detect the number of unique accessors to the UI 440 from the web analytics information described above. Additionally or alternatively, the auction server 102 may detect the number of unique accessors by excluding any repeated access to the UI 440 from the same device identifier (a device identifier may be an Internet Protocol address (IP address) or a Media Access Control (MAC) address, for example). In some further embodiments, the UI 440 of the electronic auction may be accessed only after logging into a user account associated with the auction server 102 and so, the auction server 102 may detect the number of unique accessors by excluding any repeated access to the UI 440 from the same user account.

Where the interest indicator is a detected manipulation of a user interface control provided in the UI 440 of the electronic auction, the auction server 102 may detect manipulation of the user interface control before receiving the input for purchasing the product at the current price. The user interface control for which detection is possible may, for example, be selected from a group of controls consisting of an editable field, a combo box, a check box, a radio button, and a drop-down list. The manipulation may vary depending on the type of control. For example, for a text field that allows a user to specify the number of the product to purchase, manipulation may include the entering of text into the text field. For a drop-down list, manipulation may include the activation of the drop-down list so that the options of the list are shown, and/or the selection of a value in the list shown. It will be understood that the above listed user interface controls are merely examples and that other controls may be used.

The auction system 102 may be operable to determine an interest level from these interest indicators. An interest level may be a numerical score or value that can be associated with the input received from the interest indicator. Such associations may vary depending on the type of auction and the type of interest indicator. For example, if the interest indicator is a rate at which the product is being purchased, the rate at which an interest level is considered high may depend on the type or number of products for sale, and/or the length of the auction time period.

When monitoring the interest in the auction, the auction server 102 may determine interest level in the auction at different points in time during the auction period. Specifically, the auction server 102 may determine a first interest level from the interest indicator at a first point in time during the auction time period and determine a second interest level from the interest indicator at a second point in time, after the first point in time, during the auction time period.

At step 240, the auction server 102 may decrease the current price by a variable price decrement as the auction time period decreases, where the variable price decrement corresponds inversely with the interest in the electronic auction.

At step 250, the auction server 102 may display the current price on the UI 440 as the current price decreases.

Reference is now made simultaneously to FIGS. 3, 4A, 4B and 4C, in which an example auction for “100 units” of tablet computers will be discussed to illustrate steps 240 and 250. The example auction is set for an auction time period of 5 hours, and a starting price of $300. The current price for the product is initially set to decrement $2 every 10 minutes.

As discussed above, FIG. 3 illustrates a line graph that plots the current price over time for the example auction. In particular, FIG. 3 illustrates the current price decreasing by a variable price decrement amount after each of a number of time intervals (referred to generally herein as a “price update time interval”) ‘10 min’ 310, ‘20 min’ 320, and ‘30 min’ 330 that are a portion of the overall auction time period. It will be understood that the duration of any price update time interval may be configured and modified, for example, depending on the type of product being sold. FIGS. 4A, 4B and 4C illustrate screenshots 400, 400′, 400″ of an example UI for displaying the auction at different points in time corresponding to when the time intervals 310, 320, and 330 have elapsed respectively.

The example screenshots in FIGS. 4A, 4B and 4C share some common features. As illustrated, the product identification field 470 indicates that in the example auction, the product available for sale is tablet computers. The available quantity field 480 indicates that “100 units” are available for purchase in the auction, and the start price field 450 indicates that the start price is $300. As noted above, the start price field 450 may be considered a static field in that it remains unchanged through the duration of the auction time period.

In contrast, the dynamic fields on the UI 440 may vary (e.g., be updated) over time during the auction.

At the first point in time after the first price update time interval 310, FIG. 4A shows the current price field 455 to be $298, a price point corresponding to point 315 on the graph in FIG. 3. To arrive at this price point, the auction server 102 has decreased the start price 305 by the first price decrement amount 307 (e.g., $2) after the first price update time interval 310 has elapsed.

The auction server 102 may then use an interest indicator to monitor interest in the auction and determine a variable price decrement amount. The auction server 102 may determine the next price decrement amount based on the determined interest level. To determine the next price decrement amount, the auction server 102 may monitor one or more interest indicators associated with the auction as illustrated in the UI 440 of FIG. 4A. For example, the auction server 102 may monitor the rate at which the tablet computer is purchased during the price update time interval (e.g., the remaining quantity field 485 indicating that “95 units” remain such that only “5 units” of tablet computers have been sold over a period of 10 minutes). In another example, the auction server 102 may monitor the frequency at which the user interface 440 is accessed (e.g., the number of visitors field indicating the site having “20 visitors” over a period of 10 minutes). In a further example, the auction server 102 may monitor to determine whether one or more of the product information control 422 and quantity selecting control 420 have been manipulated by a user. Additionally, the auction server 102 may monitor the number of unique accessors to the UI 440 by, for example, retrieving the number of unique accessors from the database for storing information related to the auction.

Based on the interest indicators (either individually or in some combination thereof), the auction server 102 may determine that there is a low interest level in the electronic auction. For example, the auction server 102 may determine that “20 visitors” are too few, and/or that the quantity sold (“5 units”) during the first price update time interval is too low.

Accordingly, the auction server 102 may increase the price decrement amount at the next price update interval 320.

Continuing with the example with reference now to FIG. 4B, illustrated therein generally as 400′, is an example user interface for the electronic auction after a second price update time interval has elapsed during the set auction time period, in accordance with an embodiment of the present disclosure. Specifically, the illustrated example screenshot 400′ is a screenshot of the user interface 440′ of the electronic auction at a second point in time 320 during the auction time period, after another price update time interval has elapsed since the example screenshot 400 in FIG. 4A.

Referring simultaneously to both FIGS. 3 and 4B, as illustrated in FIG. 4B, the UI still reflects a low interest in the auction prior to the point in time 320. The number of visitors field 425′ indicates that “25 visitors” have accessed the UI 440′ (e.g., only 5 additional visitors have accessed the UI 440′ since the first price update time interval 310 elapsed as illustrated in the UI 440 of FIG. 4A) and the remaining quantity field 485′ indicates that still, only 5 units of tablet computers have been purchased (e.g., no additional purchases have been made since the first price update time interval 310 elapsed as illustrated in the UI 440 of FIG. 4A). The remaining time left field 460′ is also updated to display that 4 hours and 40 minutes remain in the auction.

FIG. 4B, however, shows that the increased price decrement amount, has taken effect. The current price shown in the current price field 455′ in FIG. 4B (corresponding to the current price 325 illustrated in FIG. 3) indicates that the auction server 102 has decreased the current price shown in FIG. 4A by the second price decrement amount 317 (e.g., $30). Notably, the auction server 102 has varied the decrement amount inversely with the interest level in the auction. That is, the price decrement amount has increased (from $2 to $30) as a result of the low interest level in the auction.

As a result of the lower current price 325, the interest level in the auction may rise. Such higher interest may be detected, for example, through the manipulation of the quantity selecting control 420′ to invoke the drop-down list to make the list visible by a user.

In response to the higher interest level in the auction, the auction system 102 may decrease the price decrement amount at the next price update time interval 330.

Still continuing with the example but now with reference to FIG. 4C, illustrated therein generally as 400″, is a an example user interface for the electronic auction after the third price update time interval 330 elapsed during the auction time period, in accordance with an embodiment of the present disclosure. Specifically, the example screenshot 400″ illustrates the user interface 440″ for the electronic auction after a further price update time interval has elapsed since the example screenshot 400′ in FIG. 4B.

As a result of the large price decrease after the second price upgrade time interval 320, some of the dynamic fields of the auction illustrated in FIG. 4C reflect the results of the higher interest level in the auction. Particularly, the number of visitors field 425″ indicates that “225 visitors” have accessed the UI 440″ (an increase of “200 visitors” from FIG. 4B) and the remaining quantity field 485″ indicates that 80 units of tablet computers have been purchased and that only “20 units” of the table computers are remaining.

FIG. 4C also shows that the decreased price decrement has taken effect. The current price in the current price field 455″ in FIG. 4C (corresponding to price point 335 in FIG. 3) indicates that the auction server 102 has decreased the current price 455′ in FIG. 4B by the third price decrement amount 327 (e.g., $6) after the third price update time interval 330 elapsed. Notably, the auction server 102 has again varied the decrement amount inversely with the interest level in the auction. That is, the price decrement amount has lowered (from $30 to $6) as a result of the higher interest level in the auction.

As alluded to above, in various embodiments, the auction server 102 may perform monitoring of interest in the electronic auction using a plurality of interest indicators. That is, the auction server 102 may monitor interest by using any combination of interest indicators. For example, the auction server 102 may monitor interest by determining both the rate at which the product is purchased and the number of unique accessors of the UI 440. It will be understood that the described combinations of the interest indicators are merely examples, and that other combinations of the interest indicators may be used.

In such embodiments, the auction server 102 may calculate a final interest level based on the interest levels determined from the multiple individual interest indicators. In some embodiments, the auction server 102 may calculate a final interest level by determining an average of the interest level associated with each interest indicator. In some variant embodiments, the auction server 102 may calculate a final interest level by determining a sum of the interest levels associated with each interest indicator. In some further embodiments, the auction server 102 may calculate a final interest level by determining a weighted average of the interest level associated with each interest indicator.

In various embodiments, the auction server 102 may determine two interest levels from the interest indicator(s) at different points in time during the auction time period and compare the two interest levels to determine the variable price decrement amount to use. That is, the auction server 102 may determine a first interest level from the interest indicator(s) determined at a first point in time during the auction time period (e.g., for the example auction discussed above, the first point in time may be the point in time after the second price update time interval 320 elapsed) and similarly, the auction server 102 may determine a second interest level from the interest indicator(s) determined at a second point in time during the auction time period (e.g., for the example auction discussed above, the second point in time may be the point in time after the third price update time interval 330 elapsed).

Referring again simultaneously to FIGS. 3, 4B and 4C, the auction server 102 determined that the interest indicators at the second point in time (e.g., after the third price update time interval 330 elapsed) indicates a higher interest level than the interest level indicated by the interest indicators at the first point in time (e.g., after the second price update time interval 320 elapsed). Therefore, the price decrement amount 327 at the second point in time may be configured to be lower than the price decrement amount 317 at the first point in time.

Up until this point, the discussion of interest indicators has generally centered around their use in varying the price decrement amount. However, the subject embodiments are also directed at using interest indicators to vary other aspects of the electronic auction. For example, in various embodiments, the auction server 102 may be configured to monitor the interest in the electronic auction by determining another interest level from the interest indicator at another point in time during the auction time period (which may not necessarily coincide with the same points in time in which interest levels for modifying the price decrement amount as assessed). If the auction server 102 determines that this another interest level is higher than a predefined extension interest level, the auction server may vary the auction end time by extending the auction end time.

Generally, the predefined extension interest level is a threshold interest level (that may be set by an auction administrator, for example) at which the auction server 102 determines there to be sufficient interest in the auction for the auction time period of the auction to be extended, that is, for the auction end time to be extended or delayed. The predefined extension interest level may be stored in the database related to the auction and may be retrieved from the database(s) by the auction server 102.

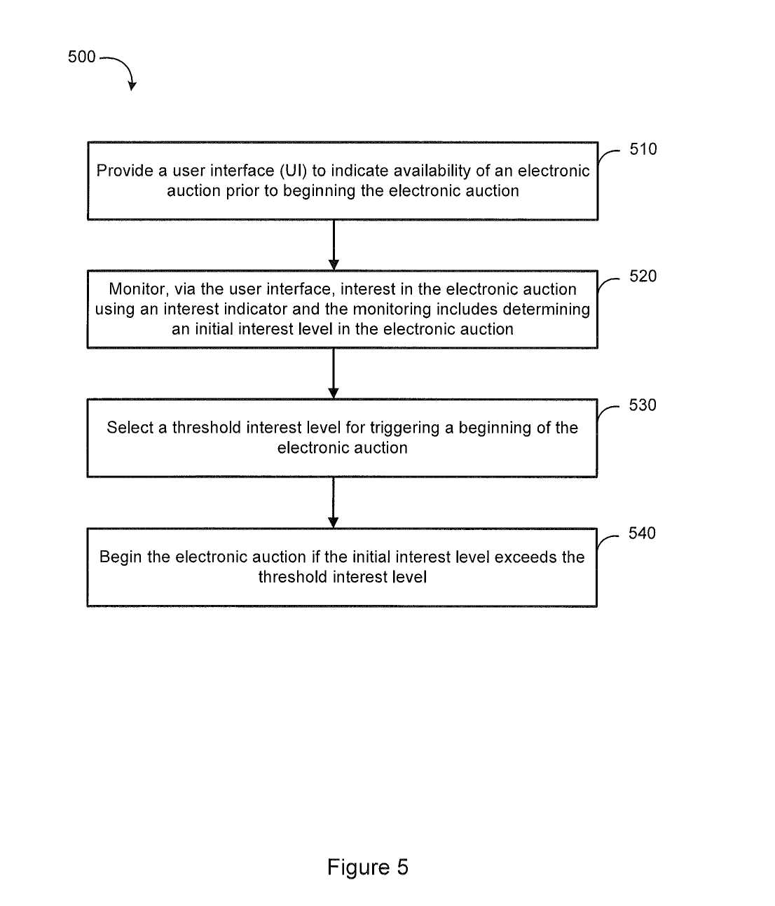

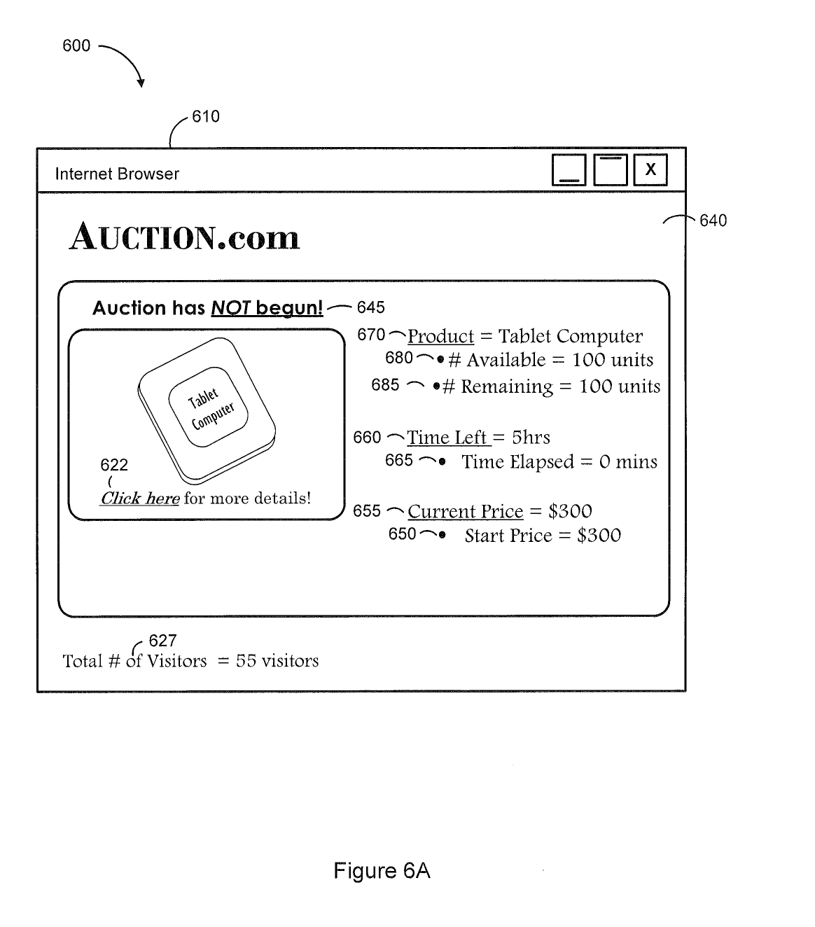

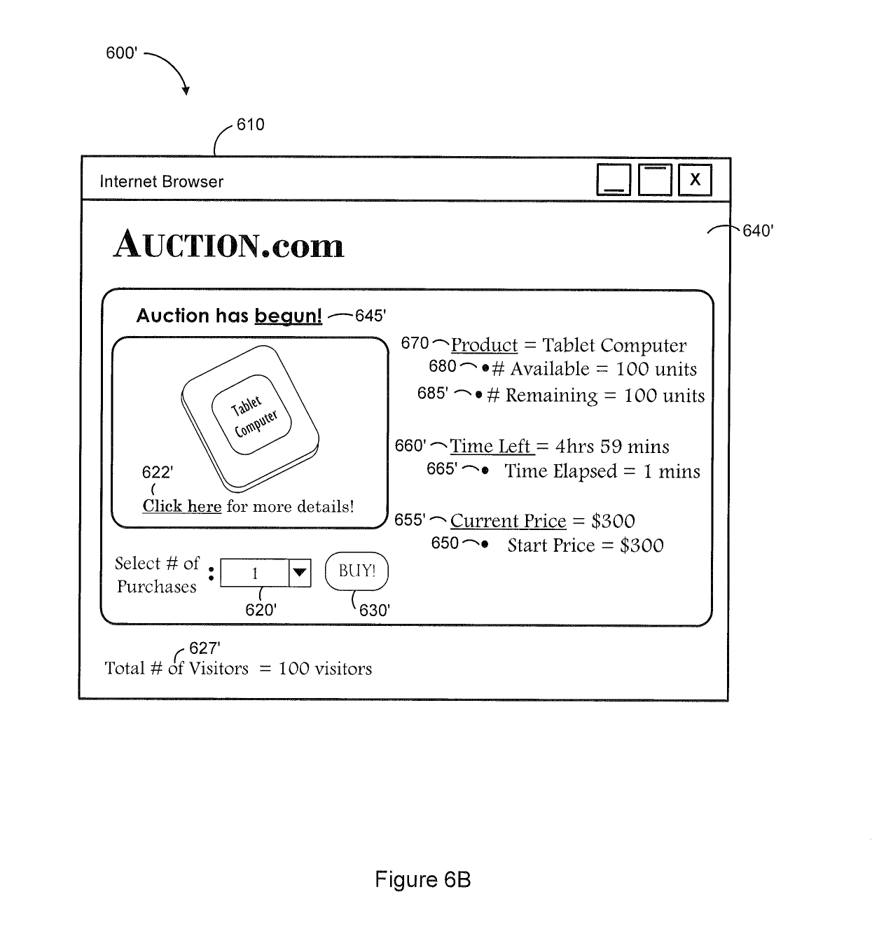

Referring now to FIG. 5, illustrated therein generally as 500, is a flowchart diagram illustrating the steps of conducting an electronic auction, in accordance with another embodiment of the present disclosure. To illustrate the steps of the method, reference will be made simultaneously to FIG. 6A, which illustrates a screenshot of an example user interface for the electronic auction.

At step 510, the auction server 102 may provide a user interface (UI) to indicate availability of an electronic auction prior to beginning the electronic auction.

The auction server 102 may provide a user interface that is similar to the user interface described above with reference to Step 220 of FIG. 2. As illustrated in FIG. 6A, the UI 640 for the electronic auction in FIG. 6A is similar to the UI 440 illustrated in FIG. 4A. For example, as described with respect to the UI 440 in FIG. 4A, an auction status field 645 may be included in the UI 640 for indicating the status of the electronic auction.

It will be understood, however, that the UI 640 may include different fields and/or controls from that of the UI 440 in FIG. 4A. For example, as illustrated in FIG. 6A, a total preview visitors field 627 displaying a total number of auction preview visitors to the webpage may be included instead of the number of visitors since the auction began field 425 provided on the UI 440 in FIG. 4A. The example screenshot 600 is merely an example and other display configurations may be used when providing the UI 640 for the electronic auction.

Generally, the auction server 102 may make the UI 640 for the electronic auction available for access prior to beginning the auction. That is, in some embodiments, where the UI 640 may be published on an electronic webpage, the UI 640 may be accessible from an internet browser 610 on the computing devices 104, 104′ before the auction begins. In some other embodiments, the UI 440 for the electronic auction may be published through one or more smartphone applications and accessed from one or more smartphone devices 104, 104′ before the auction begins.

At step 520, the auction server 102 may monitor, via the UI, interest in the electronic auction using an interest indicator and the monitoring may include determining an initial interest level in the electronic auction.

As described above with respect to Step 230 of FIG. 2, the auction server 102 may be operable to determine an interest level from the interest indicator associated with the electronic auction (e.g., an initial interest level).

In some embodiments, the interest indicator may be a frequency at which the UI 640 is accessed. As described above in relation to Step 230 of FIG. 2, the auction server 102 may detect the frequency at which the UI is accessed from, for example, web analytics information.

In some other embodiments, the interest indicator may be a number of unique accessors of the UI 640. Determination of the number of unique accessors is described above in relation to Step 230 of FIG. 2.

In some further embodiments, the interest indicator may be a detected manipulation of a user interface control provided in the UI 640 of the electronic auction. Detection of manipulation of the user interface control by the auction server 102 is described above in relation to Step 230 of FIG. 2.

In some further embodiments, as described above, the auction server 102 may perform monitoring of interest in the electronic auction by using a plurality of interest indicators. That is, the auction server 102 may monitor interest by determining the initial interest level using more than one of the interest indicators. In some embodiments, the auction server 102 may monitor interest by determining the number of unique accessors of the UI 640, the frequency at which the UI 640 is accessed, and whether any of the user interface controls has been detected. It will be understood that the described combinations of the interest indicators are merely examples, and that other combinations of the interest indicators may be used.

At step 530, the auction server 102 may select a threshold interest level for triggering a beginning of the electronic auction.

The threshold interest level is an interest level at which the auction server 102 determines there to be sufficient interest in the auction for the auction to begin. The predefined threshold interest level may be stored in the database for storing information related to the auction and may be retrieved from the database(s) by the auction server 102.

For example, referring still to FIG. 6A, the auction status field 645 indicates that the auction has not begun. To trigger the beginning of the electronic auction, the auction server 102 needs to determine that there is sufficient interest in the auction to exceed the threshold interest level. Determination of the interest in the auction based on the interest indicators by the auction server 102 is discussed above.

At step 540, the auction server 102 may begin the electronic auction if the initial interest level exceeds the threshold interest level.

As the auction server 102 monitors the interest using the interest indicators and determines that the initial interest level in the electronic auction is higher than the threshold interest level, the auction server 102 may begin the electronic auction.

In some embodiments, the auction server 102 may continue to monitor the interest in the electronic auction using the interest indicator after the electronic auction has begun, as described above with respect to Step 230 of FIG. 2. As well, the auction server 102 may decrease the current price of the product by a variable price decrement as the auction time period for completing the auction decreases, such that the variable price decrement corresponds inversely with the interest in the electronic auction, as described above with respect to Step 240 of FIG. 2.

By waiting until there is a high level of interest in the auction before beginning the auction, the auction server 102 may be able to sell the items being auctioned off at the highest price possible by, for example, avoiding price decrements when there is a low interest level in the auction. When coupled with the embodiments described above in which there is a variable price decrement (e.g., embodiments where a low interest level may result in a large price decrement), waiting to start the auction may be desirable in avoiding a scenario where the auction server 102 needs to raise the price decrement to increase interest in the auction.

An example of conducting an electronic auction for a product, as described with reference to FIG. 5, as well as FIGS. 6A and 6B (which are screenshots of an example user interface for an electronic auction at different points in time during the auction time period) is now discussed.

The threshold interest level for triggering the beginning of the electronic auction may be stored in the database(s) for storing information related to the auction and retrieved by the auction server 102. Generally, the interest level may be selected in any form that enables a comparison of one value with another value, that is, a determination of whether a first value is greater, equal or less than a second value. In some embodiments, the interest level may be in a form of a numeral. In some other embodiments, the interest level may be in a form of an alphabet (e.g., an interest level “C” may be less than an interest level “D”). In some other embodiments, the auction server 102 may group similar interest levels together (e.g., certain similar interest levels are grouped as “low” interest levels, and certain other similar interest levels are grouped as “high” interest levels).

As described above, FIG. 6A, illustrated therein generally as 600, is a screenshot of an example webpage for the electronic auction, in accordance with an embodiment of the present disclosure.

In the illustrated example screenshot 600, a user interface (UI) 640 for the electronic auction is presented on an electronic webpage and accessed from an internet browser 610 of a computing device 104. The UI 640 in FIG. 6A is similar to the UI 440 in FIG. 4A, and therefore, for purpose of consistency, the components that are similar as between the figures are referred to with similar reference numerals.

As illustrated in FIG. 6A, various details about the auction may be provided in various data fields on the UI 640. Similar to the UI 440 in FIG. 4A, the data fields may include one or more static fields for displaying information that do not change throughout a course of the auction and one or more dynamic fields for displaying information that are updated at different time intervals during the auction. The one or more static fields may include a product identification field 670 that identifies a product for auction, a start price field 650 that displays a start price of the product, and an available number field 680 that displays an available number of the product.

The one or more dynamic fields may include an auction status field 645 identifying a status of the auction (e.g., whether the auction has not begun, begun or ended), a current price field 655 that displays a current price of the product, a remaining time field 660 that displays a remaining time left for which the auction is available, a time elapsed field 665 that indicates time elapsed since the auction began, a remaining quantity field 685 that displays a remaining quantity of the product, and a total preview visitors field 627 that identifies a total number of visitors to the auction webpage. In some embodiments, the total preview visitors field 627 may display a total of each and every access of the UI 640. In some other embodiments, the total preview visitors field 627 may display a number of only unique accessors of the UI 640, that is, repeated access of the UI by the same computing device 104 and/or user is excluded from the total.

As previously described, data information corresponding to both the static and dynamic data fields may be stored in the database(s) for storing information related to the auction. The auction server 102 may populate, and/or update if applicable, these data fields by retrieving the corresponding data information from the database(s).

Furthermore, as described with respect to the UI 440 in FIG. 4A above, one or more controls may be included in the UI 640 of an electronic auction for receiving input from the user, such as for example, a product information control 622 (e.g., a “Click here” URL link 622) for receiving input from the user for requesting additional information regarding the product on auction. Notably, in FIG. 6A, since the auction has not begun, there is no purchasing control (e.g., a ‘Buy’ button 430 illustrated in FIG. 4A) for receiving input from the user for purchasing the product, or a quantity selecting control (e.g., a drop-down list 420 illustrated in FIG. 4A) for receiving input from the user selecting the quantity of the product to be purchased.

The product information control 622 is an example of a user interface control that is capable of being manipulated before the electronic auction begins. The auction server 102 may, therefore, detect manipulation of the control when a user clicks on the product information control 622 before the auction begins.

It will be understood that these described fields are merely examples, and that fewer and/or additional fields may be provided on the UI 640 for the electronic auction. It will also be understood that the organization of the UI 640 is merely an example, and that other display configurations may be used.

As illustrated in the example UI 640 in FIG. 6A, the product field 670 indicates that the product for auction are tablet computers, the available quantity field 680 indicates that “100 units” of tablet computers are available for purchase in the auction, and the start price field 650 indicates that the start price is $300. Since these data fields are generally static, the same fields remain unchanged in the illustrated screenshot shown in FIG. 6B which is at a subsequent point in time to the screenshot shown in FIG. 6A.

In contrast, the dynamic fields in the UI 640 may vary over time, that is, even before the auction begins and also during the auction. As illustrated in FIG. 6A, the auction status field 645 indicates that the auction has not begun. Generally, data fields on the UI 640 that are related to auction parameters remain unchanged until the auction begins. For example, the current price field 655 displays the same value as that of the start price field 650 (e.g., $300), the time elapsed field 665 displays “0 mins” has elapsed, the remaining quantity field 685 displays the same value as the available quantity field 680 (e.g., “100 units” of tablet computers) since the auction has not begun, the remaining time left field 660 indicates that “5 hrs” remain in the auction (e.g., the total time for which the auction is available since the auction has not begun).

However, there are data fields on the UI 640 that may change even before the auction begins. For example, in FIG. 6A, the total preview visitors field 627 indicates that 55 visitors have accessed the UI 640 even though the auction has not begun. Similarly, the UI 640 may include user interface controls that are capable of being manipulated before the electronic auction has begun. Examples include the product information control 622 (e.g., in FIG. 6A, the “Click here” link is selected).

For determining the initial interest level in the electronic auction, the auction server 102 monitors one or more interest indicators associated with the auction illustrated in the UI 640 in FIG. 6A. For example, the auction server 102 may monitor the frequency at which the user interface 640 is accessed (e.g., 55 visitors, for example). Additionally, the auction server 102 may monitor the number of unique accessors of the UI 640 by, for example, retrieving the number of unique accessors from the database for storing information related the auction. Further, the auction server 102 may monitor more than one of these interest indicators. Determination, by the auction server 102, of the initial interest level in the auction based on the interest indicators is discussed above with respect to Step 230 in FIG. 2.

In this example, the auction server 102 determines that the initial interest level, based on the interest indicators associated with the auction illustrated in the UI 640 in FIG. 6A, exceeds the selected threshold interest level. For example, the threshold interest level may be that over 50 visitors are required to view the page. As a result, the auction server 102 may begin the electronic auction.

Continuing with the example with reference now to FIG. 6B, illustrated therein generally as 600′, is an example user interface 640′ for the electronic auction at a later point in time than the user interface 640 of FIG. 6A, in accordance with an embodiment of the present disclosure. Specifically, the illustrated example screenshot 600′ illustrates the user interface 640′ after the electronic auction has begun, as indicated by the status field 645′.

As illustrated in FIG. 6B, the auction server 102 has updated the content of several fields since the auction as illustrated in the UI 640 of FIG. 6A. For example, the remaining time left field 660′ now displays 4 hours and 59 minutes (e.g., the time elapsed field 665′ indicates that 1 minute has elapsed since the electronic auction began). In a further example, the total preview visitors field 627′ on FIG. 6B indicates that 100 visitors have accessed the UI 640′ (e.g., an additional 45 visitors have accessed the UI 640′ when compared with the total preview visitors field 627 in the UI 640 of FIG. 6A).

Also, the UI 640′ in FIG. 6B includes other fields with content that may change as the auction progresses. For example, the remaining quantity field 685′ and the current price field 655′.

The present invention has been described here by way of example only. Various modification and variations may be made to these exemplary embodiments without departing from the spirit and scope of the invention, which is limited only by the appended claims.

We claim:

1. A method of conducting an electronic auction for a product at a server, wherein a finite number of the product is available at a current price and the current price decreases as an auction time period for completing the electronic auction decreases, the method comprising the server:
setting the auction time period for completing the electronic auction;
providing a user interface for receiving an input for purchasing one or more of the finite number of the product at the current price;
monitoring interest in the electronic auction using an interest indicator associated with the electronic auction;
decreasing the current price by a variable price decrement as the auction time period decreases, wherein the variable price decrement corresponds inversely with the interest in the electronic auction; and
displaying the current price on the user interface as the current price decreases.

2. The method of claim 1, wherein
the monitoring comprises:
determining a first interest level from the interest indicator at a first point in time during the auction time period;
determining a second interest level from the interest indicator at a second point in time, after the first point in time, during the auction time period; and
the decreasing the current price comprises:
decreasing the current price by a first price decrement amount at the first point in time; and
decreasing the current price by a second price decrement amount at the second point in time.

3. The method of claim 1, wherein the second interest level is lower than the first interest level and the second price decrement amount is greater than the first price decrement amount.

4. The method of claim 1, wherein the second interest level is higher than the first interest level and the second price decrement amount is less than the first price decrement amount.

5. The method of claim 1, wherein the first interest level is substantially the same as the second interest level, and the first price decrement amount is the same as the second price decrement amount.

6. The method of claim 1, further comprising:
determining a rate at which the product is purchased, the rate comprising a quantity of product purchased over a portion of the auction time period; and
wherein the interest indicator comprises the rate.

7. The method of claim 1, further comprising
detecting a frequency at which the user interface is accessed over a portion of the auction time period; and wherein the interest indicator comprises the frequency.

8. The method of claim 1, further comprising:
detecting a number of unique accessors of the user interface over a portion of the auction time period; and wherein the interest indicator comprises the number of unique accessors.

9. The method of claim 1, wherein the user interface comprises a user interface control capable of being manipulated before the user interface receives the input for purchasing one or more of the finite number of product at the current price, the method further comprising:
detecting manipulation of the user interface control prior to the user interface receiving input for purchasing the product at the current price; and wherein the interest indicator comprises the detected manipulation.

10. The method of claim 9, wherein the user interface control is selected from the group consisting of: an editable field, a combo box, a check box, a radio button, and a drop-down list.

11. The method of claim 1, further comprising:
displaying, on the user interface, a remaining quantity of the finite number of the product that has not been purchased; and
updating the remaining quantity on the user interface, after receiving the input for purchasing one or more of the finite number of the product.

12. The method of claim 1, wherein the auction time period comprises an auction start time and an auction end time, the method further comprising:
varying the auction end time in correspondence with the interest in the electronic auction.

13. The method of claim 12, wherein the monitoring further comprises:
determining a third interest level from the interest indicator at a third point in time during the auction time period; and
the varying the auction end time further comprises:
extending the auction end time if the third interest level is higher than a predefined extension interest level.

14. A method of conducting an electronic auction for a product at a server, wherein a finite number of the product is available at a current price and the current price decreases as an auction time period for completing the electronic auction decreases, the method comprising the server:
providing a user interface to indicate availability of the electronic auction prior to beginning the electronic auction;
monitoring, via the user interface, interest in the electronic auction using an interest indicator, wherein the monitoring comprises determining an initial interest level in the electronic auction;
selecting a threshold interest level for triggering a beginning of the electronic auction; and
beginning the electronic auction if the initial interest level exceeds the threshold interest level.

15. The method of claim 14, wherein the monitoring interest in the electronic auction comprises:
detecting a frequency at which the user interface is accessed; and wherein the interest indicator comprises the frequency.

16. The method of claim 14, wherein the monitoring interest in the electronic auction comprises:
detecting a number of unique accessors of the user interface; and wherein the interest indicator comprises the number of unique accessors.

17. The method of claim 14,
wherein the user interface comprises a user interface control capable of being manipulated; and
wherein the monitoring interest in the electronic auction comprises detecting manipulation of the user interface control, and the interest indicator comprises the detected manipulation.

18. The method of claim 14, further comprising:
monitoring the interest in the electronic auction using the interest indicator after beginning the electronic auction; and
decreasing the current price by a variable price decrement as the auction time period decreases, wherein the variable price decrement corresponds inversely with the interest in the electronic auction.

19. The method of claim 1, wherein the monitoring interest in the electronic auction is performed using a plurality of interest indicators.
